(19) United States
(12) Patent Application Publication
(10) Pub. No.: US 2012/0313538 A1
(43) Pub. Date: Dec. 13, 2012

(54) DIMMING BALLAST FOR ELECTRODELESS LAMP

(75) Inventors: Nitin Kumar, Burlington, MA (US); Markus Ziegler, San Pedro Garza Garcia (MX); Shashank Bakre, Woburn, MA (US)

(73) Assignee: OSRAM SYLVANIA INC., Danvers, MA (US)

(21) Appl. No.: 13/155,104

(22) Filed: Jun. 7, 2011

(51) Int. Cl. H05B 37/02

(52) U.S. Cl. 315/200 R

(57) ABSTRACT

A ballast to energize a lamp at a selected lighting level is provided. The ballast includes a rectifier, a buck converter, and a controller. The rectifier produces a DC voltage with a substantially constant magnitude. The buck converter generates a lamp voltage output from the DC voltage based on a duty cycle. The output has a magnitude that is varied based on the duty cycle to energize the lamp at a selected lighting level. The controller receives a dim input signal indicating the selected lighting level, and provides an appropriate control signal to the buck converter. The appropriate control signal indicates a particular duty cycle corresponding to magnitude of the output to produce the selected lighting level. In response to receiving the control signal, the buck converter adjusts the duty cycle accordingly, producing the output having the magnitude to energize the lamp at the selected lighting level.

### TECHNICAL FIELD

The present invention relates to lighting, and more specifically, to ballasts for powering lamps.

### BACKGROUND

Lighting systems that operate at multiple lighting levels are typically used in various lighting applications, such as in overhead lighting. Such lighting systems conserve energy, because they allow the level of light output by the system to be less than the maximum possible light level, when maximum light is not necessary. In addition to providing energy savings, multiple level lighting systems enhance productivity in commercial environments by providing those in the workplace with the ability to customize the lighting level in their individual work spaces.

### SUMMARY

Conventional lighting systems that operate at multiple lighting levels can be costly and require many additional components. For example, a typical implementation of a two level lighting system includes two power switches and two ballasts. Each power switch in the lighting system controls only one of the ballasts. Turning on both of the switches at the same time powers both ballasts, thus producing the maximum possible (or full) light output. Turning on only one of the switches applies power to only one of the ballasts in the lighting system, and thus results in a reduced light output (level) and a corresponding reduction in power consumed.

However, it is more economical to have a single ballast in the lighting system rather than two ballasts. One implementation of a two level lighting system using only a single ballast requires two switches and two lamp sets. In an alternative implementation of a two level lighting system having a single ballast, the ballast includes two controllers, each of which controls a lamp set. In order to shut off one lamp set, the supply voltage to the controller corresponding to the one lamp set is pulled down (e.g., grounded) so that the controller is disabled. However, this implementation is not energy efficient, because even though a controller is disabled, the supply voltage for that controller is still being pulled from the power supply. Thus, it is desirable to have an energy efficient, cost effective, compact lighting system that is capable of providing multiple light levels.

Embodiments of the present invention provide a multiple level lighting system using a single ballast. In one embodiment, the ballast includes a rectifier for receiving an alternating current (AC) voltage signal from an AC power supply and producing a direct current (DC) voltage signal therefrom. A power factor correction circuit is connected to the rectifier for boosting the DC signal produced by the rectifier. A buck converter is connected to the power factor correction circuit and receives the boosted DC voltage signal therefrom. The boosted DC voltage signal has a magnitude that is substantially constant. The buck converter has a duty cycle that is used to generate, from the boosted DC voltage signal, a DC lamp voltage output signal that has a magnitude that is varied in order to energize the lamp at multiple lighting levels.

A controller is connected to buck converter circuit for controlling the duty cycle of the buck converter. In particular, the controller is configured to receive a dim input signal that is indicative of a selected lamp lighting level. For example, the lighting system may include one or more dim interfaces, such as a step dim interface or a continuous dim interface. The one or more dim interfaces are connected to the controller for allowing a user to select a lamp lighting level and then providing the dim input signal indicative of the selected lamp lighting level to the controller. The controller is configured to provide a control signal to the buck converter as a function of the dim input signal. The control signal indicates a particular duty cycle for the buck converter that corresponds to a lamp voltage output signal that has a magnitude for energizing the lamp at the selected lighting level. Responsive to receiving the control signal, the buck converter circuit adjusts the duty cycle according to the control signal to produce the lamp voltage signal having the specified magnitude for energizing the lamp at the selected lighting level.

In an embodiment, there is provided a ballast to energize a lamp at a lighting level selected from a plurality of lamp lighting levels. The ballast includes: a rectifier to receive an alternating current (AC) voltage signal from an AC power supply and produce a direct current (DC) voltage signal therefrom; a buck converter circuit connected to the rectifier to receive the DC voltage signal, wherein the DC voltage signal has a magnitude that is substantially constant, the buck converter circuit has a duty cycle to generate a lamp voltage output signal from the DC voltage signal, the lamp voltage output signal applied to the lamp to energize the lamp, wherein the lamp voltage output signal has a magnitude that is varied by the duty cycle to energize the lamp at the plurality of lamp lighting levels; and a controller connected to the buck converter circuit, the controller configured to receive a dim input signal that is indicative of the selected lamp lighting level, the controller configured to provide a control signal to the buck converter circuit as a function of the dim input signal, the control signal indicating a particular duty cycle for the buck converter circuit that corresponds to a lamp voltage output signal having a magnitude to energize the lamp at the selected lamp lighting level; wherein in response to the buck converter receiving the control signal, the buck converter circuit adjusts the duty cycle according to the control signal to produce the lamp voltage output signal having the magnitude to energize the lamp at the selected lamp lighting level.

In a related embodiment, the ballast may further include a dim interface connected to the controller, the dim interface configured to receive user input indicative of the selected lamp lighting level.

In a further related embodiment, the dim interface may be a step dim interface, the step dim interface configured to receive user input indicative of the selected lamp lighting level, wherein the selected lamp lighting level is selected from a number of lamp lighting levels. In a further related embodiment, the step dim interface may include a switch connected between the AC power supply and the controller, the switch configured to operate between a first state and a second state, wherein the step dim interface is configured to generate a dim input signal indicating that the selected lamp lighting level is a first lamp lighting level when the switch is operated in the first state, and wherein the step dim interface is configured to generate a dim input signal indicating that the selected lamp lighting level is a second lamp lighting level when the switch is operated in the second state.

In another further related embodiment, the dim interface may be a continuous dim interface, the continuous dim interface configured to receive user input indicative of the selected lamp lighting level, wherein the selected lamp lighting level is selected from a continuous spectrum of lamp lighting levels.

In another related embodiment, the ballast may further include a step dim interface connected to the controller and a continuous dim interface connected to the controller, the step dim interface providing a number of selectable lamp lighting levels, the continuous dim interface providing a continuous spectrum of selectable lamp lighting levels, wherein the controller is configured to receive the selected lamp lighting level from one of the step dim interface and the continuous dim interface. In yet another related embodiment, the ballast may further include a power regulation circuit to regulate power generated by the buck converter circuit. In a further related embodiment, the power regulation circuit may include a current feedback circuit to sense current generated by the buck converter circuit, and a voltage feedback circuit to sense voltage generated by the buck converter circuit, the current feedback circuit and the voltage feedback circuit being connected to the controller. In a further related embodiment, the controller may be configured to receive a current feedback signal from the current feedback circuit, the current feedback signal indicative of the current generated by the buck converter circuit, and wherein the controller is configured to receive a voltage feedback signal from the voltage feedback circuit, wherein the controller is configured to determine the power generated by the buck converter circuit as a function of the current feedback signal and the voltage feedback signal, and the controller is configured to adjust the duty cycle of the buck converter circuit as a function of the power determined to be generated by the buck converter circuit.

In still another related embodiment, the buck converter circuit may operate in critical conduction mode. In yet another related embodiment, the ballast may further include a power factor correction circuit connected between the rectifier and the buck converter circuit. In still yet another related embodiment, the ballast may further include an inverter connected between the buck converter circuit and the lamp.

In another embodiment, there is provided a ballast to energize a lamp at a lighting level selected from a plurality of lamp lighting levels. The ballast includes: a rectifier to receive an alternating current (AC) voltage signal from an AC power supply and produce a direct current (DC) voltage signal therefrom; a power factor correction circuit connected to the rectifier to boost the DC voltage signal produced by the rectifier; a buck converter circuit connected to the power factor correction circuit to receive the boosted DC voltage signal from the power factor correction circuit, wherein the boosted DC voltage signal has a magnitude that is substantially constant, the buck converter circuit has a duty cycle to generate a DC lamp voltage output signal from the boosted DC voltage signal, wherein the DC lamp voltage output signal has a magnitude that is varied by the duty cycle in order to energize the lamp at the plurality of lamp lighting levels; a controller connected to the buck converter circuit, the controller configured to receive a dim input signal that is indicative of the selected lamp lighting level, the controller configured to provide a control signal to the buck converter circuit as a function of the dim input signal, the control signal indicating a particular duty cycle for the buck converter circuit that corresponds to a lamp voltage output signal having a magnitude to energize the lamp at the selected lamp lighting level; and an inverter connected to the buck converter circuit to convert the DC lamp voltage output signal to an AC lamp voltage output signal to energize the lamp at the selected lamp lighting level; wherein in response to the buck converter receiving the control signal, the buck converter circuit adjusts the duty cycle according to the control signal to produce the lamp voltage output signal having the magnitude to energize the lamp at the selected lamp lighting level.

In a related embodiment, the ballast may further include a dim interface connected to the controller, the dim interface configured to receive user input indicative of the selected lamp lighting level. In a further related embodiment, the dim interface may be a step dim interface, the step dim interface configured to receive user input indicative of the selected lamp lighting level, wherein the selected lamp lighting level is selected from a number of lamp lighting levels. In another further related embodiment, the dim interface may be a continuous dim interface, the continuous dim interface configured to receive user input indicative of the selected lamp lighting level, wherein the selected lamp lighting level is selected from a continuous spectrum of lamp lighting levels.

In yet another related embodiment, the ballast may further include a step dim interface connected to the controller and a continuous dim interface connected to the controller, the step dim interface providing a finite number of selectable lamp lighting levels, the continuous dim interface providing a continuous spectrum of selectable lamp lighting levels, wherein the controller is configured to receive the selected lamp lighting level from one of the step dim interface and the continuous dim interface. In still another related embodiment, the ballast may further include a power regulation circuit to regulate power generated by the buck converter circuit. In a further related embodiment, the power regulation circuit may include a current feedback circuit to sense current generated by the buck converter circuit, and a voltage feedback circuit to sense voltage generated by the buck converter circuit, the current feedback circuit and the voltage feedback circuit being connected to the controller. In a further related embodiment, the controller may be configured to receive a current feedback signal from the current feedback circuit, the current feedback signal indicative of the current generated by the buck converter circuit, and wherein the controller is configured to receive a voltage feedback signal from the voltage feedback circuit, wherein the controller is configured to determine the power generated by the buck converter circuit as a function of the current feedback signal and the voltage feedback signal, and the controller is configured to adjust the duty cycle of the buck converter circuit as a function of the power determined to be generated by the buck converter circuit.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a schematic diagram, partially in block form, of a lamp system according to embodiments disclosed herein.

FIG. 2 shows a schematic diagram of a buck converter circuit of the lamp system of FIG. 1 according to embodiments disclosed herein.

FIG. 3 shows an exemplary pin out diagram of a controller according to embodiments disclosed herein.

### DETAILED DESCRIPTION

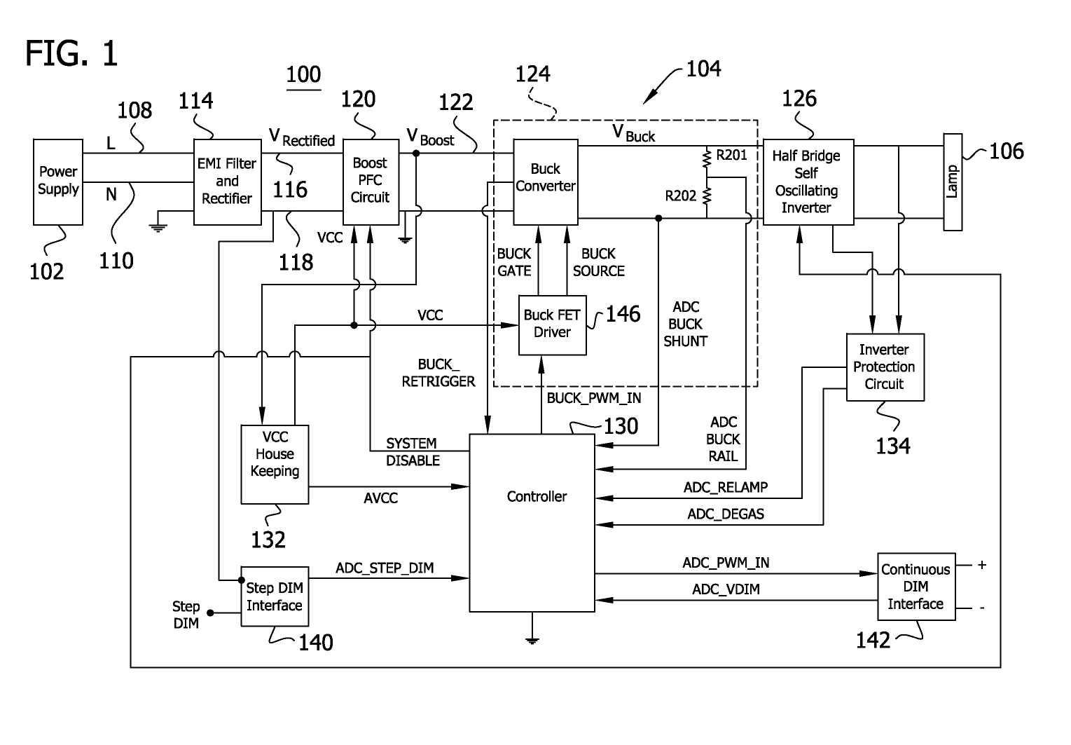

FIG. 1 illustrates a lamp system 100. The lamp system 100 includes an input power source, such as an alternating current (AC) power supply 102, an electronic ballast 104 (hereinafter ballast 104), and a lamp 106. It should be noted that the lamp 106 may be a single lamp, or may be a plurality of lamps connected together in series. In some embodiments, the lamp 106 is an electrodeless lamp, such the ICETRON® lamp available from OSRAM SYLVANIA. However, the scope of the application contemplates the use of other types of lamps as well.

The ballast 104 includes at least one high voltage input terminal (i.e., line voltage input terminal) 108 adapted for connecting to the alternating current (AC) power supply (e.g., standard 120V AC household power), a neutral input terminal 110, and a ground terminal connectable to ground potential (not illustrated). An input AC power signal is received by the ballast 104 from the AC power supply 102 via the high voltage input terminal 108. The ballast 104 includes an electromagnetic interference (EMI) filter and a rectifier (e.g., full-wave rectifier) 114, which are illustrated together in FIG. 1. The EMI filter portion of the EMI filter and rectifier 114 prevents noise that may be generated by the ballast 104 from being transmitted back to the AC power supply 102. The rectifier portion of the EMI filter and rectifier 114 converts AC voltage received from the AC power supply 102 to direct current (DC) voltage. The rectifier portion includes a first output terminal connected to a DC bus 116 and a second output terminal connected to a ground potential at ground connection point 118. Thus, the EMI filter and rectifier 114 outputs a DC voltage (V_{Rectified}) on the DC bus 116.

A power factor correction circuit 120, which may, in some embodiments, be a boost converter, is connected to the first and second output terminals of the EMI filter and rectifier 114. The power factor correction circuit 120 receives the rectified DC voltage (V_{Rectified}) and produces a high DC voltage (V_{Boost}) on a high DC voltage bus (“high DC bus”) 122. For example, the power factor correction circuit 120 may provide a voltage of around 465 volts to the high DC voltage bus 122. A DC to DC converter, such as a buck converter circuit 124, is connected to the power factor correction circuit 120 via the high DC voltage bus 122. The buck converter circuit 124 reduces the high DC voltage (V_{Boost}) received via the high DC voltage bus 122 and, thus, generates a stepped down DC voltage signal (V_{Buck}). An inverter circuit, such as half bridge self oscillating inverter 126 (hereinafter inverter 126), is connected to the buck converter circuit 124 for receiving the stepped down DC voltage (V_{Buck}) and converting it to AC voltage for supplying to the lamp 106.

As detailed below, the high DC voltage received by the buck converter circuit 124 has, in some embodiments, a fixed magnitude, and in some embodiments, a substantially fixed magnitude. The buck converter circuit 124 converts the high DC voltage to a stepped down DC voltage (V_{Buck}) that will allow the lamp 106 to operate at a lighting level selected from a plurality of lighting levels. Since the stepped down DC voltage (V_{Buck}) produced by the buck converter circuit 124 corresponds to the lighting level generated by the lamp 106, the stepped down DC voltage (V_{Buck}) has a magnitude that is variable so that it can be used to operate the lamp 106 at any one of the plurality of lighting levels. For example, buck converter circuit 124 may reduce the high DC voltage from 465 volts to a voltage in the range of about 140 volts to about 440 volts in order to operate the lamp 106 at one of a plurality of lamp lighting levels. More particularly, the buck converter circuit 124 may reduce the high DC voltage from 465 volts to about 140 volts to operate the lamp 106 at first lamp lighting level (e.g., 50% of light output), or alternatively, to about 330 volts to operate the lamp 106 at a second lamp lighting level (e.g., 70% of light output), or to about 440 volts to operate the lamp 106 at yet a third lamp lighting level (e.g., 100% of light output).

The lamp system 100 includes a controller 130 for controlling components of the lamp system 100, and a power supply (VCC) house keeping circuit 132 for powering components of the lamp system 100 including the controller 130. In FIG. 1, the lamp system 100 includes an inverter protection circuit 134 connected to the inverter 126. The inverter protection circuit 134 senses the AC voltage signal being provided to the lamp 106 and detects conditions that warrant shutting down the inverter 126. For example, the inverter protection circuit 134 detects a degas condition wherein the lamp 106 is connected to the ballast 104 but is broken, cracked, or otherwise not ignited. The inverter protection circuit 134 also detects a re-lamp condition wherein the lamp 106 is not present or because wires used to connect the lamp 106 to the ballast 104 have become disconnected during normal operation. If the inverter protection circuit 134 detects a degas condition, the inverter protection circuit 134 indicates the presence of the condition to the controller 130 via input signal ADC^{—}DEGAS. If the inverter protection circuit 134 detects a re-lamp condition, the inverter protection circuit 134 indicates the presence of the condition to the controller 130 via input signal ADC^{—}RELAMP. In response to receiving an indication of either the degas condition or the re-lamp condition from the inverter protection circuit 134, the controller 130 shuts down the power factor correction circuit 120 and the inverter 126 via output signal SYSTEM DISABLE and also turns the buck converter circuit 124 OFF by turning off the gate drive signal BUCK^{—}PWM^{—}IN.

The controller 130 also communicates with a dim interface (described further below) and with the buck converter circuit 124 in order control the buck converter circuit 124 so that it generates a stepped down DC voltage (V_{Buck}) that corresponds to a lamp lighting level selected by a user via the dim interface. The illustrated lamp system 100 includes two dim interfaces, a step dim interface 140 and a continuous dim interface 142, that may be used alternatively to select a lamp lighting level. However, it should be noted that one or more dim interfaces may be used to select the lamp lighting level without departing from the scope of the invention. The step dim interface 140 allows a user to select a lamp lighting level from a finite number of lamp lighting levels. The continuous dim interface 142 allows a user to select a lamp lighting level from a continuous spectrum of lamp lighting levels.

In some embodiments, the step dim interface 140 comprises one or more switches connected to the input terminal(s) (high voltage input terminal 108 and/or neutral input terminal 110) of the ballast 104 between the input terminal(s) and the controller 130. Each switch configuration corresponds to a lamp lighting level. Thus, a user selects a particular lamp lighting level by manipulating the one or more switches (e.g., conventional wall switches) to a particular switch configuration. The step dim interface 140 receives a signal (STEP DIM) indicative of the particular switch configuration and generates a DC voltage signal, ADC STEP, based on the switch configuration. The DC voltage signal, ADC STEP, is provided to the controller 130 to indicate the selected lamp lighting level. For example, the step dim interface 140 may comprise a switch connected to the high voltage input terminal 108 between the power supply and the controller 130. A user selects a first lamp lighting level (e.g., 100% of lamp output) by manipulating the switch to operate in the first configuration, and selects a second lamp lighting level (e.g., 50% of lamp output) by manipulating the switch to operate in a second configuration. When the switch is in the first configuration (e.g., closed, ON), the step dim interface 140 generates the DC voltage signal, ADC STEP, to have a first voltage level. On the other hand, when the switch is in the second configuration (e.g., open, OFF), the step dim interface 140 generates the DC voltage signal, ADC STEP, to have a second voltage level. In response to receiving the DC voltage signal, ADC STEP, having the first voltage level, the controller 130 operates the buck converter circuit 124 so that it produces a stepped down DC voltage (V_{Buck}) having a first magnitude for powering the lamp 106 at the first lamp level (e.g., 100% of lamp output). Similarly, in response to receiving the DC voltage signal, ADC STEP, having the second voltage level, the controller 130 operates the buck converter circuit 124 so that it produces a stepped down DC voltage (V_{Buck}) having a second magnitude for powering the lamp 106 at the second lamp level (e.g., 50% of light output).

In some embodiments, the continuous dim interface 142 allows a user to select a voltage from a continuous voltage range of 0 volts to 10 volts. The voltages in the range of 0 volts to 10 volts correspond to lamp lighting levels for producing a range of light output from the lamp 106. For example, the voltages in the range of 0 volts to 10 volts may correspond to lamp lighting levels for producing light output in the range of 40% to 100% of light output for the lamp 106. Thus, a user selects a lamp lighting level by selecting a voltage from the continuous range of voltages. When a user selects the voltage from the continuous range of voltages, the continuous dim interface generates a DC voltage signal, ADC^{—}VDIM, indicative of the selected voltage. In response to receiving the DC voltage signal, ADC^{—}VDIM, the controller 130 operates the buck converter circuit 124 so that it produces a stepped down DC voltage (V_{Buck}) having magnitude for powering the lamp 106 at the selected lamp level. As illustrated, the controller 130 also provides the continuous dim interface 142 with a pulse width modulated signal (e.g., ADC^{—}PWM^{—}IN) to enable operation thereof as generally known in the art.

In the lamp system 100, the buck converter circuit 124 operates as a switched-mode power supply which has a duty cycle that may be adjusted (e.g., modified) in order to vary power (i.e., current and voltage) produced by the buck converter circuit 124. In particular, the duty cycle of the buck converter circuit 124 may be adjusted to vary the magnitude of the DC voltage signal (V_{Buck}) that is produced by the buck converter circuit 124 from the high DC voltage fixed magnitude signal (V_{Boost}) received by the buck converter circuit 124. In operation, the lamp system 100 receives user input via a dim interface (i.e., step dim interface 140 or continuous dim interface 142 or, in some embodiments, both) which indicates a selected lamp lighting level. In response to receiving the user input, the dim interface (i.e., step dim interface 140 or continuous dim interface 142, or, in some embodiments, both) generates a dim input signal (e.g., DC voltage signal ADC STEP or ADC^{—}VDIM) and provides the dim input signal to the controller 130. The controller 130 determines a duty cycle (e.g., on switching time and off switching time) for the buck converter circuit 124 that will step down the high DC voltage fixed magnitude signal (V_{Boost}) to generate a DC voltage signal (V_{Buck}) having a magnitude for energizing the lamp 106 at the selected lamp lighting level. The controller 130 provides a control signal (BUCK^{—}PWM^{—}IN) to the buck converter circuit 124 indicating the determined duty cycle. In response to receiving the control signal (BUCK^{—}PWM^{—}IN) from the controller 130, the buck converter circuit 124 adjusts the duty cycle to the determined duty cycle in order to produce the DC voltage signal (V_{Buck}) having a magnitude for energizing the lamp 106 at the selected lamp lighting level.

As illustrated in FIG. 1, the buck converter circuit 124 includes a buck converter 144 that is ground referenced. Since the buck converter 144 is ground referenced, the buck converter circuit 124 also includes a buck FET driver 146, such as part FAN7382 High- and Low-Side Gate Driver available from Fairchild Semiconductor. Thus, the buck FET driver 146 receives the control signal (BUCK^{—}PWM^{—}IN) from the controller 130 and generates switch control signals, BUCK GATE and BUCK SOURCE, for controlling the duty cycle of the buck converter 144 in accordance with the duty cycle indicated in the control signal (BUCK^{—}PWM^{—}IN) received by the FET driver 146. It should be noted that other buck converter circuits or step down DC to DC converters may be used without departing from the scope of the invention.

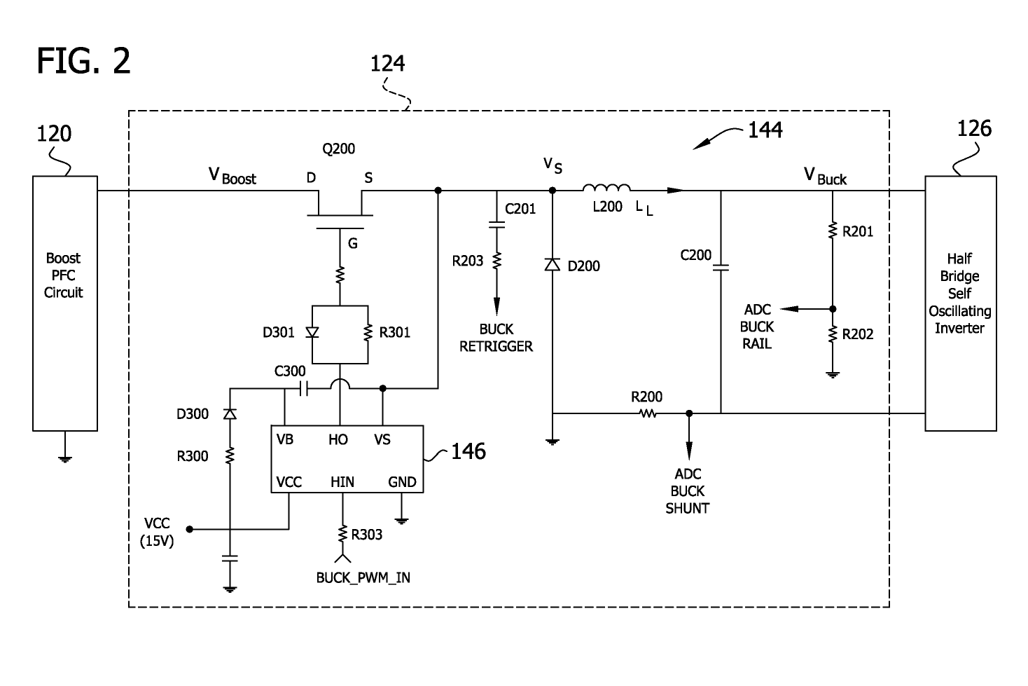

FIG. 2 shows a schematic of an exemplary buck converter circuit 124. As generally known, the buck converter circuit 124 includes a first switch, a second switch, an inductor, and a capacitor. In accordance therewith, the illustrated buck converter circuit 124 includes a metal—oxide—semiconductor field-effect transistor (buck MOSFET) Q200, a buck diode D200, a buck inductor L200, and a buck capacitor C200. The buck MOSFET Q200 has a drain terminal, a gate terminal, and a source terminal. It should be noted that other or additional components could be used without departing from the scope of the invention. For example, rather than using diode D200, the second switch could be another MOSFET connected with the buck MOSFET Q200 so as to generate complementary gate drive outputs.

Referring again to the illustrated buck converter circuit 124, the MOSFET Q200 and the buck diode D200 operate so as to alternately connect and disconnect the buck inductor L200 to the boost PFC circuit 120. In other words, the buck inductor L200 alternately receives the high DC voltage (V_{Boost}) from the boost PFC circuit 120 as a function of the buck MOSFET Q200 and the buck diode D200. When the buck MOSFET Q200 is conductive (e.g., closed; ON), current flows from the boost PFC circuit 120 through the buck inductor L200, the buck capacitor C200, and a shunt resistor R200. The high DC voltage (V_{Boost}) from the boost PFC circuit 120 reverse-biases the buck diode D200, so no current flows through the buck diode D200. On the other hand, when the buck MOSFET Q200 is non-conductive (e.g., open; OFF), the buck diode D200 is forward biased and thus conducts current. Accordingly, current flows in a path from the buck inductor 200 and passing through the buck capacitor C200, the shunt resistor R200, and the buck diode D200. Thus, the buck inductor 200 stores energy (e.g., charges) from the boost PFC circuit 120 while the buck MOSFET Q200 is conductive and dissipates energy (e.g., discharges) to the inverter 126 while the MOSFET Q200 is non-conductive. The amount of time that the buck MOSFET Q200 is conductive during a period of one conductive and one non-conductive state (i.e., during a period) is the duty cycle for the buck converter circuit 124.

In some embodiments, the buck converter circuit 124 is configured to operate in critical conduction mode. As illustrated in FIG. 2, the buck converter circuit 124 includes circuit components in addition to those discussed above to support operation of the buck converter circuit 124 in this mode. In particular, the buck converter circuit 124 includes a boot strapping circuit (i.e., capacitor C300, diode D300, and resistor R300) connected between the source terminal of the buck MOSFET Q200 and the power supply for providing a sufficient gate to source voltage for the buck MOSFET Q200. Turn off diode D301 and gate resistors R301 and R302 are connected between the gate terminal of the buck MOSFET Q200 and the buck FET driver 146. A current limiting resistor R303 is connected between the controller 130 and the buck FET driver 146, and a V_{cc} capacitor C301 is connected between the buck FET driver 146 and ground potential. An inductor current sensing circuit comprising capacitor C201 and resistor R203 is connected between the source terminal of the buck MOSFET Q200 and the buck inductor L200 and to the controller 130. The inductor sensing circuit provides an input signal (BUCK RETRIGGER) to the controller 130 indicative of the current through the buck inductor L200. Upon receiving an indication via the BUCK RETRIGGER signal that the current through the buck inductor L200 has reached zero, the controller 130 sends a signal (BUCK^{—}PWM^{—}IN) to the buck FET driver 146 to turn the buck MOSFET Q200 on. The BUCK^{—}PWM^{—}IN also indicates the length of time (T_{ON}) that the MOSFET Q200 should be conductive to produce the voltage for generating the selected lamp lighting level.

Referring to FIGS. 1 and 2, in some embodiments, the ballast 104 includes a power regulation circuit for the buck converter 144. As discussed above, the buck converter circuit 124 includes a shunt resistor R200 (broadly, “current feedback circuit”) connected at the output of the buck converter 144 between the buck capacitor C200 and ground potential for measuring (e.g., monitoring) current output from the buck converter 144. In particular, the controller 130 is connected to the shunt resistor R200, and receives a current feedback signal ADC BUCK SHUNT which is representative of the current through the shunt resistor R200. The buck converter circuit 124 also includes a resistive network (broadly, “voltage feedback circuit”) connected at the output of the buck converter 144 for measuring the voltage produced by the buck converter 144. In the illustrated embodiment, the buck converter circuit 124 includes a first resistor R201 and a second resistor R202 connected together in series. The series connected first and second resistors R201 and R202 are connected parallel with the buck capacitor C200 between the buck converter circuit 124 and the inverter 126. The controller 130 is connected between the first resistor R201 and the second resistor R202 for receiving a voltage feedback signal ADC BUCK RAIL, which is representative of the DC voltage V_{Buck} produced by the buck converter 144.

The controller 130 determines the actual power being generated by the buck converter circuit 124 as a function of the current feedback signal ADC BUCK SHUNT and the voltage feed back signal ADC BUCK RAIL. The controller 130 compares the actual power being generated by the buck converter circuit 124 to a target power. The target power is the power (i.e., voltage and current) needed to operate the lamp 106 at the selected lamp lighting level. The controller 130 controls (e.g., modifies) the duty cycle of the buck converter circuit 124 via the control signal BUCK^{—}PWM^{—}IN as a function of the comparison between the actual power and the target power. For example, if the selected lamp lighting level is 60% light output, and the lamp is a 100 Watt lamp, the target power is 60 Watts. If the controller 130 receives current and voltage feedback signals indicating that the power produced by the buck converter circuit 124 is 65 Watts, the controller 130 indicates via the control signal BUCK^{—}PWM^{—}IN that the duty cycle should be reduced so that only 60 Watts are provided to the lamp 106.

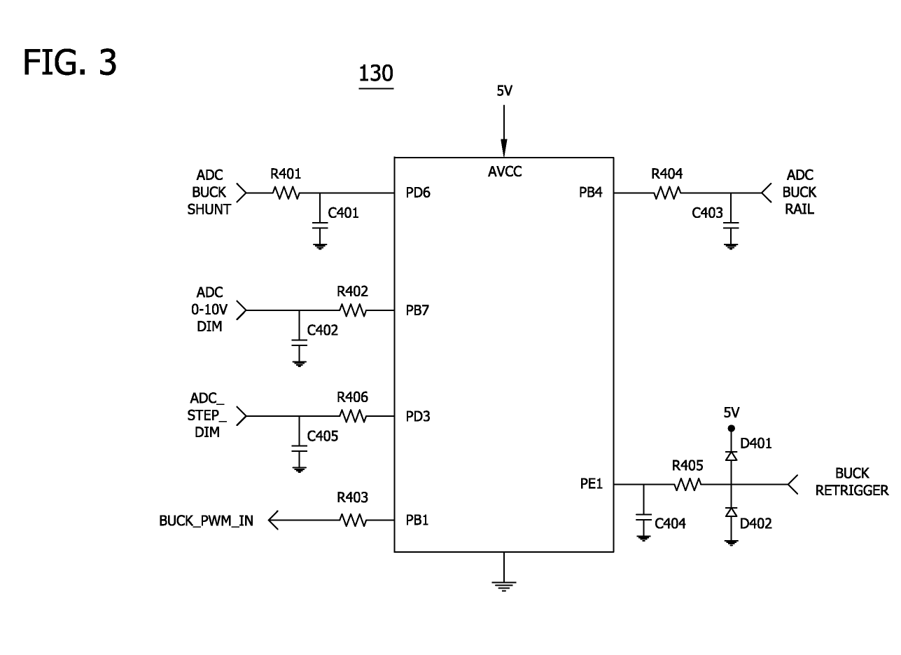

FIG. 3 illustrates an exemplary pin out diagram for a controller 130. As discussed above, the controller 130 receives a power supply AVCC for powering the controller 130 from the VCC house keeping circuit 132. The controller 130 is configured to receive a step dim input signal ADC^{—}STEP^{—}DIM via a first RC filter circuit (i.e., a resistor R406 and a capacitor C405), and a continuous dim input signal ADC^{—}VDIM via a second RC filter circuit (i.e., a resistor R402 and a capacitor C402). The dim input signals (ADC^{—}STEP^{—}DIM and ADC^{—}VDIM) indicate a selected lamp lighting level. The controller 130 controls the duty cycle of the buck converter 144 via a control signal BUCK^{—}PWM^{—}IN and a current sensing signal BUCK RETRIGGER. In particular, the controller 130 is configured to monitor the current through the buck inverter L200 via current sensing signal BUCK RETRIGGER. When the current sensing signal BUCK RETRIGGER indicates that the current across through the buck inverter L200 reaches zero, the controller 130 indicates to the buck FET driver 146 via the control signal (BUCK^{—}PWM^{—}IN) that the duty cycle should be turned on and specifies the length of time (Tₒₙ) for which it should be on (Tₒₙ). The controller 130 determines the length of time that the duty cycle should be on as a function of the dim input signals (ADC^{—}STEP^{—}DIM and ADC^{—}VDIM).

The controller 130 is configured to receive a current feedback signal (ADC BUCK SHUNT) via a third RC filter circuit (i.e., a resistor R401 and a capacitor C401) and a voltage feedback signal (ADC BUCK RAIL) via a fourth RC filter circuit (i.e., a resistor R404 and a capacitor C403). Together, the current feedback signal (ADC BUCK SHUNT) and the voltage feedback signal (ADC BUCK RAIL) indicate the power generated by the buck converter 144. The controller 130 compares the power generated by the converter 144 to a target power that it determines from the dim input signals (ADC^{—}STEP^{—}DIM and ADC^{—}VDIM). The controller 130 is configured to control the duty cycle of the buck converter 144 via the control signal (BUCK^{—}PWM^{—}IN) in accordance with the comparison so that the buck converter 144 produces the target power for generating the selected lamp lighting level.

Though embodiments are described herein with reference to various hardware components, in some embodiments, software may alternatively be used to accomplish some and/or all of the same functionality without departing from the scope of the invention. Alternatively, or additionally, a combination of software and hardware may be used. Thus, for example, in some embodiments, the controller 130 may include firmware (i.e., software instructions) that, when executed on a processor within the controller 130, perform the various calculations, determinations, measurements, and sensing functions that may otherwise be performed by hardware components (i.e., resistors, capacitors, and the like). In such embodiments, the controller 130 includes a memory system, either internal to the controller 130 or external or a combination of both, that stores the firmware as well as various values needed by the firmware to perform operations and intermediary values produced by the firmware during those operations and as output of those operations.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A ballast to energize a lamp at a lighting level selected from a plurality of lamp lighting levels, the ballast comprising:
a rectifier to receive an alternating current (AC) voltage signal from an AC power supply and produce a direct current (DC) voltage signal therefrom;
a buck converter circuit connected to the rectifier to receive the DC voltage signal, wherein the DC voltage signal has a magnitude that is substantially constant, the buck converter circuit has a duty cycle to generate a lamp voltage output signal from the DC voltage signal, the lamp voltage output signal applied to the lamp to energize the lamp, wherein the lamp voltage output signal has a magnitude that is varied by the duty cycle to energize the lamp at the plurality of lamp lighting levels; and
a controller connected to the buck converter circuit, the controller configured to receive a dim input signal that is indicative of the selected lamp lighting level, the controller configured to provide a control signal to the buck converter circuit as a function of the dim input signal, the control signal indicating a particular duty cycle for the buck converter circuit that corresponds to a lamp voltage output signal having a magnitude to energize the lamp at the selected lamp lighting level;
wherein in response to the buck converter receiving the control signal, the buck converter circuit adjusts the duty cycle according to the control signal to produce the lamp voltage output signal having the magnitude to energize the lamp at the selected lamp lighting level.

2. The ballast of claim 1, further comprising a dim interface connected to the controller, the dim interface configured to receive user input indicative of the selected lamp lighting level.

3. The ballast of claim 2, wherein the dim interface is a step dim interface, the step dim interface configured to receive user input indicative of the selected lamp lighting level, wherein the selected lamp lighting level is selected from a number of lamp lighting levels.

4. The ballast of claim 3, wherein the step dim interface comprises a switch connected between the AC power supply and the controller, the switch configured to operate between a first state and a second state, wherein the step dim interface is configured to generate a dim input signal indicating that the selected lamp lighting level is a first lamp lighting level when the switch is operated in the first state, and wherein the step dim interface is configured to generate a dim input signal indicating that the selected lamp lighting level is a second lamp lighting level when the switch is operated in the second state.

5. The ballast of claim 2, wherein the dim interface is a continuous dim interface, the continuous dim interface configured to receive user input indicative of the selected lamp lighting level, wherein the selected lamp lighting level is selected from a continuous spectrum of lamp lighting levels.

6. The ballast of claim 1, further comprising a step dim interface connected to the controller and a continuous dim interface connected to the controller, the step dim interface providing a number of selectable lamp lighting levels, the continuous dim interface providing a continuous spectrum of selectable lamp lighting levels, wherein the controller is configured to receive the selected lamp lighting level from one of the step dim interface and the continuous dim interface.

7. The ballast of claim 1, further comprising a power regulation circuit to regulate power generated by the buck converter circuit.

8. The ballast of claim 7, wherein the power regulation circuit includes a current feedback circuit to sense current generated by the buck converter circuit, and a voltage feedback circuit to sense voltage generated by the buck converter circuit, the current feedback circuit and the voltage feedback circuit being connected to the controller.

9. The ballast of claim 8, wherein the controller is configured to receive a current feedback signal from the current feedback circuit, the current feedback signal indicative of the current generated by the buck converter circuit, and wherein the controller is configured to receive a voltage feedback signal from the voltage feedback circuit, wherein the controller is configured to determine the power generated by the buck converter circuit as a function of the current feedback signal and the voltage feedback signal, and the controller is configured to adjust the duty cycle of the buck converter circuit as a function of the power determined to be generated by the buck converter circuit.

10. The ballast of claim 1, wherein the buck converter circuit operates in critical conduction mode.

11. The ballast of claim 1, further comprising a power factor correction circuit connected between the rectifier and the buck converter circuit.

12. The ballast of claim 1, further comprising an inverter connected between the buck converter circuit and the lamp.

13. A ballast to energize a lamp at a lighting level selected from a plurality of lamp lighting levels, the ballast comprising:
a rectifier to receive an alternating current (AC) voltage signal from an AC power supply and produce a direct current (DC) voltage signal therefrom;
a power factor correction circuit connected to the rectifier to boost the DC voltage signal produced by the rectifier;
a buck converter circuit connected to the power factor correction circuit to receive the boosted DC voltage signal from the power factor correction circuit, wherein the boosted DC voltage signal has a magnitude that is substantially constant, the buck converter circuit has a duty cycle to generate a DC lamp voltage output signal from the boosted DC voltage signal, wherein the DC lamp voltage output signal has a magnitude that is varied by the duty cycle in order to energize the lamp at the plurality of lamp lighting levels;
a controller connected to the buck converter circuit, the controller configured to receive a dim input signal that is indicative of the selected lamp lighting level, the controller configured to provide a control signal to the buck converter circuit as a function of the dim input signal, the control signal indicating a particular duty cycle for the buck converter circuit that corresponds to a lamp voltage output signal having a magnitude to energize the lamp at the selected lamp lighting level; and
an inverter connected to the buck converter circuit to convert the DC lamp voltage output signal to an AC lamp voltage output signal to energize the lamp at the selected lamp lighting level;
wherein in response to the buck converter receiving the control signal, the buck converter circuit adjusts the duty cycle according to the control signal to produce the lamp voltage output signal having the magnitude to energize the lamp at the selected lamp lighting level.

14. The ballast of claim 13, further comprising a dim interface connected to the controller, the dim interface configured to receive user input indicative of the selected lamp lighting level.

15. The ballast of claim 14, wherein the dim interface is a step dim interface, the step dim interface configured to receive user input indicative of the selected lamp lighting level, wherein the selected lamp lighting level is selected from a number of lamp lighting levels.

16. The ballast of claim 14, wherein the dim interface is a continuous dim interface, the continuous dim interface configured to receive user input indicative of the selected lamp lighting level, wherein the selected lamp lighting level is selected from a continuous spectrum of lamp lighting levels.

17. The ballast of claim 13, further comprising a step dim interface connected to the controller and a continuous dim interface connected to the controller, the step dim interface providing a finite number of selectable lamp lighting levels, the continuous dim interface providing a continuous spectrum of selectable lamp lighting levels, wherein the controller is configured to receive the selected lamp lighting level from one of the step dim interface and the continuous dim interface.

18. The ballast of claim 13, further comprising a power regulation circuit to regulate power generated by the buck converter circuit.

19. The ballast of claim 18, wherein the power regulation circuit includes a current feedback circuit to sense current generated by the buck converter circuit, and a voltage feedback circuit to sense voltage generated by the buck converter circuit, the current feedback circuit and the voltage feedback circuit being connected to the controller.

20. The ballast of claim 19, wherein the controller is configured to receive a current feedback signal from the current feedback circuit, the current feedback signal indicative of the current generated by the buck converter circuit, and wherein the controller is configured to receive a voltage feedback signal from the voltage feedback circuit, wherein the controller is configured to determine the power generated by the buck converter circuit as a function of the current feedback signal and the voltage feedback signal, and the controller is configured to adjust the duty cycle of the buck converter circuit as a function of the power determined to be generated by the buck converter circuit.
